(19) United States
(12) Patent Application Publication
(10) Pub. No.: US 2019/0101358 A1
(43) Pub. Date: Apr. 4, 2019

(54) Device and Method for Determining a Motion Characteristic of a Projectile Ejected from a Toy Gun

(71) Applicant: Bradley S. Faecher, Sudbury, MA (US)

(72) Inventor: Bradley S. Faecher, Sudbury, MA (US)

(21) Appl. No.: 15/723,233

(22) Filed: Oct. 3, 2017

(51) Int. Cl. F41G 3/32

(52) U.S. Cl. CPC F41G 3/32; G01P 3/36

(57) ABSTRACT

The invention relates to a device for determining a motion characteristic of a projectile ejected from a toy gun. The device comprises a body defining a channel for receiving a moving projectile from the toy gun; a detecting unit configured to detect motion of the projectile in the channel; and a processing module configured to generate data defining a motion characteristic of the moving projectile based on the detected motion of the projectile in the channel. The invention also relates to a device assembly having the described device, and a support releasably connectable with and provides support to the device. The support is movable between an extended configuration and a retracted configuration. When in the extended configuration, the support is adapted to stand freely on a surface to support the connected device; and when in the retracted configuration, provides a handle to allow the device to be held.

### FIELD OF THE INVENTION

The invention relates to a device for use with a toy gun and, particularly, but not exclusively, to a device and method for determining a motion characteristic of a projectile ejected from a toy gun.

### BACKGROUND OF THE INVENTION

Toy guns of various types are available in the market. Particularly, toy guns have been designed with both decorative and functional features in order to mimic the appearance, operation as well as a user's experience of real guns. For example, toy guns or toy gun systems have been developed with components to detect any bullets or projectiles ejected from the toy guns. Various features have also been incorporated into traditional toy gun to enhance the user's experience.

### OBJECTS OF THE INVENTION

An object of the present invention is to provide a device for determining a motion characteristic of a projectile ejected from a toy gun.

Another object of the present invention is to mitigate or obviate to some degree one or more problems associated with known motion characterizing devices for projectiles ejected from a toy gun, or at least to provide a useful alternative.

The above objects are met by the combination of features of the main claim; the sub-claims disclose further advantageous embodiments of the invention.

One skilled in the art will derive from the following description other objects of the invention. Therefore, the foregoing statements of object are not exhaustive and serve merely to illustrate some of the many objects of the present invention.

### SUMMARY OF THE INVENTION

In a first main aspect, the invention provides a device for determining a motion characteristic of a projectile ejected from a toy gun. The device comprises a body defining a channel for receiving a moving projectile from the toy gun; a detecting unit configured to detect motion of the projectile in the channel; and a processing module configured to generate data defining a motion characteristic of the moving projectile based on the detected motion of the projectile in the channel.

In a second main aspect, the invention provides a device assembly for determining a motion characteristic of a projectile ejected from a toy gun. The device assembly comprises the device in accordance with the first aspect; and a support adapted to releasably connect with and to provide support to the device; wherein the support is movable between an extended configuration and a retracted configuration; where, when in the extended configuration, the support is adapted to stand freely on a surface to support the connected device; and where, when in the retracted configuration, the support provides a handle to allow the device to be held.

In the third main aspect, the invention provides a method of determining a motion characteristic of a projectile ejected from a toy gun by using the device of the first aspect. The method comprises steps of detecting a first motion of the projectile entering the channel of the body by a first detecting module; detecting a second motion of the projectile exiting the channel of the body by a second detecting module; processing the first and the second motions detected from the detecting steps by the processing module; and generating data defining a motion characteristic by the processing module.

The summary of the invention does not necessarily disclose all the features essential for defining the invention; the invention may reside in a sub-combination of the disclosed features.

### BRIEF DESCRIPTION OF THE DRAWINGS

The foregoing and further features of the present invention will be apparent from the following description of preferred embodiments which are provided by way of example only in connection with the accompanying figure, of which:

FIG. 1 is a perspective view showing use of a device for determining a motion characteristic of a projectile ejected from a toy gun according to an embodiment of the present invention;

FIG. 2 is another perspective view showing the device of FIG. 1;

FIG. 3 shows a side cross-sectional view of a part of the device of FIG. 1;

FIG. 4 is a perspective view showing use of a device for determining a motion characteristic of a projectile ejected from a toy gun according to another embodiment of the present invention;

FIG. 5 shows the device of FIG. 4 arranged in an extended configuration; and

FIG. 6 shows the device of FIG. 4 arranged in a retracted configuration.

### DESCRIPTION OF PREFERRED EMBODIMENTS

The following description is of preferred embodiments by way of example only and without limitation to the combination of features necessary for carrying the invention into effect.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

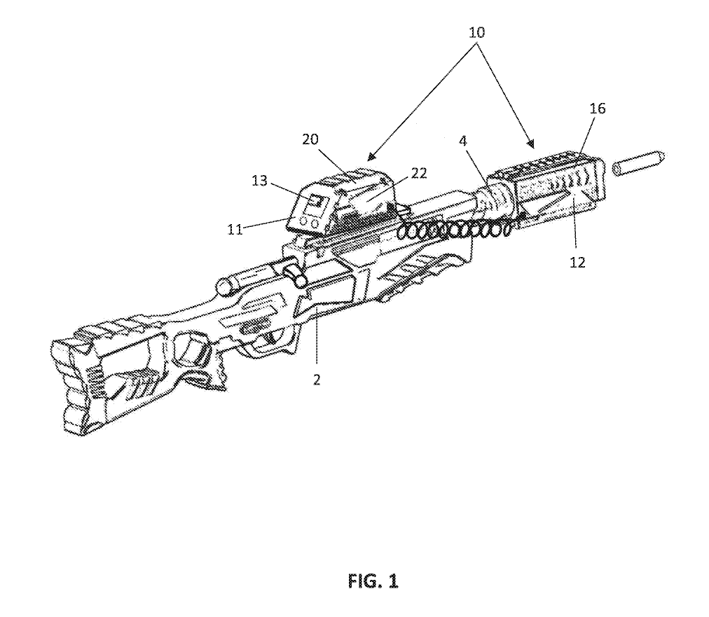

Referring to FIGS. 1 to 3, shown is an embodiment of a device 10 for use in determining a motion characteristic of a projectile ejected from a toy gun 2. The device 10 comprises a body 12 defining a channel 14 for receiving a moving projectile ejected from the toy gun 2. The device 10 further comprises a detecting unit 16 configured to detect motion of the projectile in the channel 14, and a processing module 20 configured to generate data defining a motion characteristic of the moving projectile based on the detected motion of the projectile in the channel 14. In one embodiment, the device 10 is adapted to releasably engage with at least part of the toy gun 2.

It will be understood that, in the context of the present invention, the expression “toy gun” can take a broad meaning which may encompass any toy units capable of ejecting, launching or releasing one or more projectiles; and the term “projectile” will generally refer to a projectile in any form including toy bullets, darts, arrows or the like formed of any suitable materials.

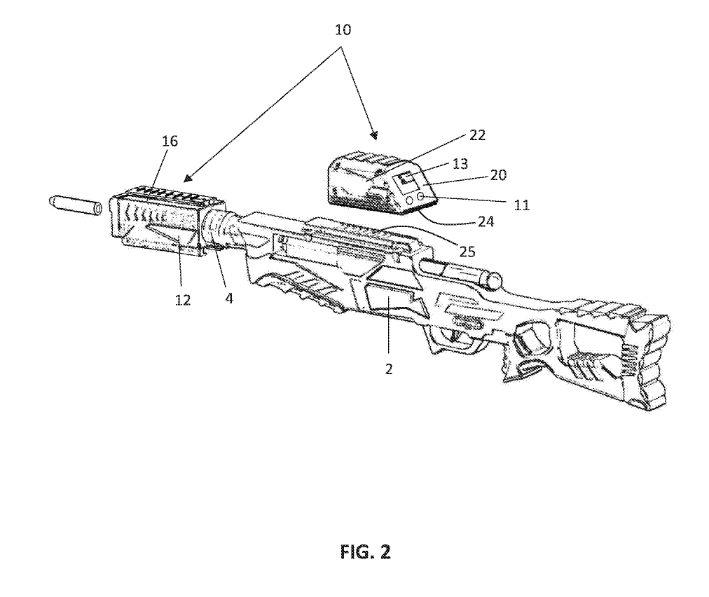

In one embodiment, the processing module 20 can be provided at a processing unit 22 with its housing being releasably mountable at a part of the toy gun 2. For example, as shown in FIGS. 1 and 2, the bottom portion of the processing unit 22 can be configured with a means 24 for connecting the processing unit 22 with an upper portion of the toy gun via a mount 25, which can be provided in the form of a rail 25 as shown in FIG. 2, for example, such that the processing unit 22 can be slidably connected with or released from the toy gun. Optionally, a similar mount 25 may also be provided on an upper portion of the body 12 of the device 10, such that the processing unit 22 can also be releasably connectable with the body 12 of the device 10.

The body 12 of the device 10 is also configured to be releasably connectable with the toy gun 2 but in such a way that, when connected, the channel 14 of the body 12 is arranged to substantially align with a nozzle 4 of the toy gun 2 for receiving the ejected projectile from the toy gun 2 and allowing the moving projectile to pass therethrough, such that the projectile will eventually exit the channel 14 from an end of the body 12 distal to the nozzle 4 and continue its flight towards the target.

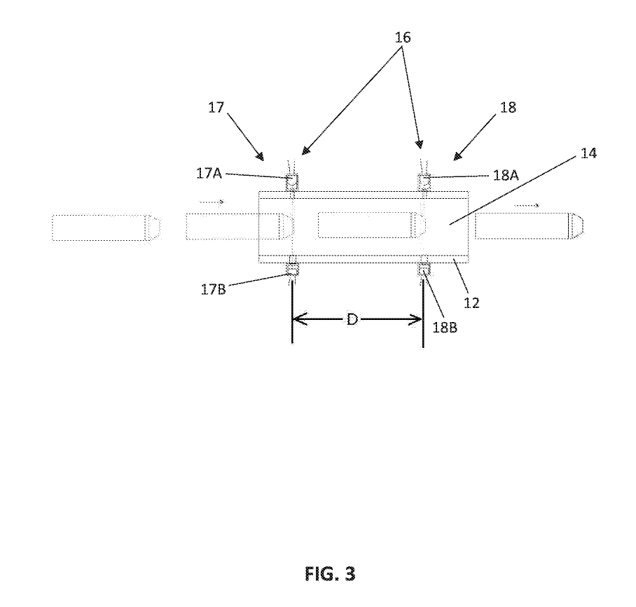

The processing module 20 is adapted to electronically connect with the detecting unit 16 by means, such as but not limited to, an electronic cable as shown in FIG. 1. Particularly, the detecting unit 16 may comprise at least a first detecting module 17 and a second detecting module 18 preferred to be spaced apart from each other along at least part of a length of the channel 14, for example, in a distance D as shown in the cross-sectional view of FIG. 3. The first detecting module 17 is adapted to detect a first motion of the moving projectile within the channel 14, which can be, but not limited to, a motion of the projectile entering the channel 14 after being ejected by the toy gun 2; and the second detecting module 18 is adapted to detect a second motion of the moving projectile within the channel 14, which can be, but not limited to, a motion of the projectile exiting the channel 14. With the first and second motions detected by the respective first and second detecting modules 17, 18, the processing module 20 is then able to process the first and the second motions to thereby generate data defining the motion characteristic of the moving projectile.

In the context of the present description, the expression “motion characteristic” generally refers to one or more parameters defining one or more characteristics in relation to the movement and/or the flight path of a projectile being ejected by the toy gun. The motion characteristic may comprise, but is not limited to, one or more of a velocity of the moving projectile, a projecting angle of the moving projectile, an acceleration of the moving projectile and an estimated distance to be traveled by the moving projectile. Nevertheless, it will be understood by a person skilled in the art that the present invention is not restricted to the disclosed characteristics or parameters, but any other motion characteristics of the moving projectile which are considered reasonably derivable from the arrangement of the present invention, shall also be encompassed.

As more clearly shown in FIG. 3, the first detecting module 17 may comprise a first electromagnetic radiation emitter 17A and a first electromagnetic radiation receiver 17B; and the second detecting module 18 may comprise a second electromagnetic radiation emitter 18A and a second electromagnetic radiation receiver 18B. The first electromagnetic radiation receiver 17B and the second electromagnetic radiation receiver 18B are each adapted to detect electromagnetic radiations emitted from the first electromagnetic radiation emitter 17A and the second electromagnetic radiation emitter 18A, respectively. To facilitate detection of the emitted electromagnetic radiation, the first electromagnetic radiation receiver 17B is preferably positioned opposite the first electromagnetic radiation emitter 17A across the channel 14, and the second electromagnetic radiation receiver 18B is preferably positioned opposite the second electromagnetic radiation emitter 18A across the channel 14. In one embodiment, the electromagnetic radiation may comprise any light transmission which include both visible and invisible light. For example, a laser or any visible light emitted from a light source. Preferably, the electromagnetic radiation may comprise infrared (IR) radiation such as in the form of an infrared (IR) beam, and more preferably, a narrow IR beam.

Preferably, the infrared (IR) radiation is at a wavelength range from about 800 nm to about 1000 nm, and more preferably, about 940 nm. In one specific embodiment, the first electromagnetic radiation emitter 17A and the second electromagnetic radiation emitter 18A may each comprise a light emitting diode (LED) and/or an IR light emitting diode (LED), which can be identical or different for the two respective emitters 17A, 18A. The first electromagnetic radiation receiver 17B and the second electromagnetic radiation receiver 18B may each comprise an IR photo-transistor and/or one or more other optoelectronic components such as a photodiode or the like, which again, can be identical or different for the two respective receivers 17B, 18B. Both the IR LEDs and the IR photo-transistors can either be customised or commodity in nature, depending on the specific configuration and requirement of the device 10.

The device 10 can be powered by any suitable power sources, such as a DC battery or electricity supply from an AC connection, or powered by a power source of the associated toy gun. The device 10 may optionally comprise a control panel 11 for inputting or adjusting control settings of the device 10, and/or a display screen 13 for displaying the determined motion characteristic of the moving projectile. The control panel 11 and/or the display screen 13 can be provided on the processing unit 22, as shown in the embodiment of FIGS. 1 and 2.

The steps for the device 10 in determining a motion characteristic of a projectile ejected from the toy gun 2 will now be elaborated by reference to the embodiment of the device 10 as shown in FIGS. 1 and 3 as an example. The moving projectile, after being ejected from the nozzle 4 of the toy gun 2, will enter the channel 14 from one end of the body 12 and subsequently exit the channel 14 from another end of the body 12. The first IR beam which is emitted by the first IR emitter 17A and which is detected by the first IR receiver 17B will first be momentarily interfered with or blocked by the entering projectile which may cut the first IR beam at an angle, and preferably, at a right angle. When the projectile continues to proceed along and pass through the channel 14, the second IR beam which is emitted by the second IR emitter 18A and which is detected by the second IR receiver 18B will subsequently be momentarily interfered with or blocked by the projectile exiting the channel 14. Particularly, the interference or blockage of the first IR beam by the entering motion of the projectile will be detected by the first detecting module 17 or more specifically, the first IR receiver 17B, which triggers a measurement of a motion-related parameter such as, for example, a time of the first interference of the first IR beam; and the interference or blockage of the second IR beam by the exiting motion of the projectile will then be detected by the second detecting module 18 or more specifically, the second IR receiver 18B, which triggers the measurement of another motion-related parameter such as, for example, a time of the second interference of the second IR beam. The difference between the two times of interference will be processed by the processing module 20 to provide a flight time for the predetermined distance D between the two sets of detecting modules 17, 18. Alternatively, detection of the second interference or blockage of the second IR beam may stop a timer from time recording since the first interference, which may also effectively provide a flight time of the projectile over the predetermined distance D. In one specific embodiment, the predetermined distance D is preferred to be about 4 inches (10 cm) to about 6 inches (15 cm). A motion characteristic of the moving projectile such as the velocity of the projectile can then be calculated based on the calculated flight time and the predetermined distance D by the processing module 20. The velocity data may then be displayed on the displayed screen 13.

In one embodiment, the detecting module 16 may further comprise one or more motion sensors (not shown) such as an accelerometer which may function independently or cooperatively with the first and the second detecting units 17, 18 for determining one or more other parameters or characteristics of the moving projectile, for example, a projecting angle of the moving projectile, an acceleration of the moving projectile and an estimated distance to be traveled by the moving projectile. The accelerometer can be digital or analog in nature, and is capable of calculating in real time a motion characteristic of the moving projectile such as, but not limited to, a projecting angle of the moving projectile. The accelerometer, when operating with one or more microcontroller or intelligent logic system, may further calculate based on the detected motions other motion characteristics of the projectile, such as but not limited to, a horizontal velocity component Vx, a vertical velocity component Vy, a resultant velocity, and/or an estimated distance to be traveled by the detected moving projectile, etc.

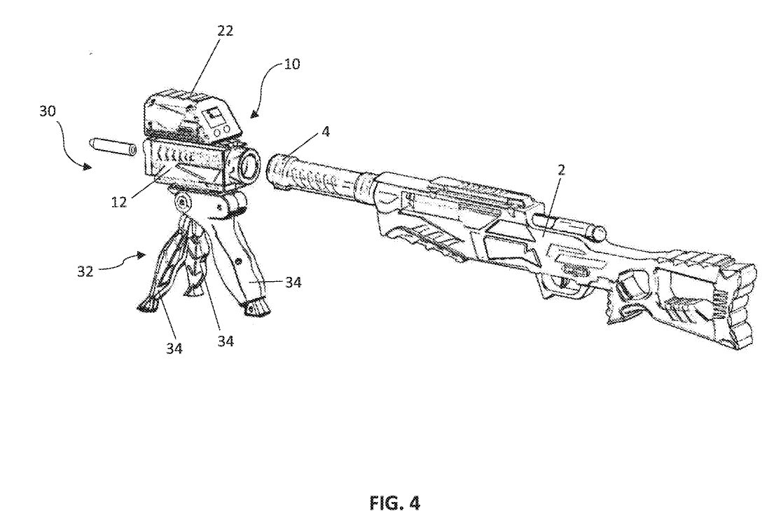

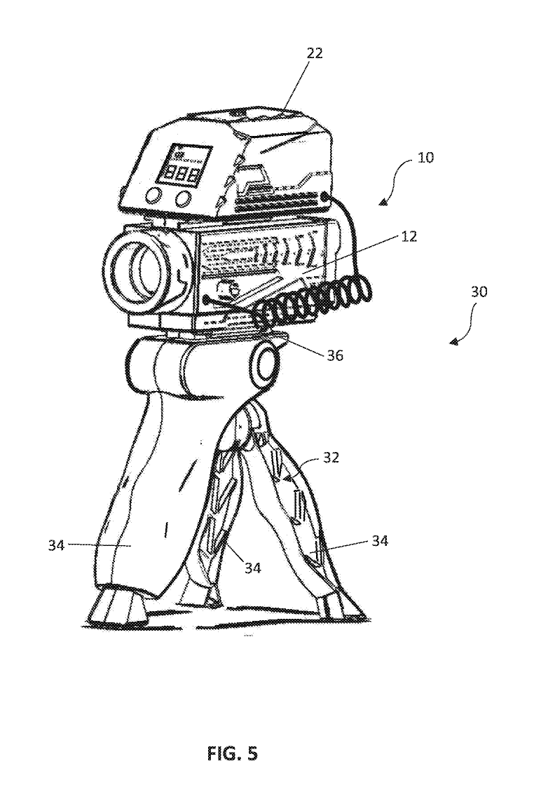

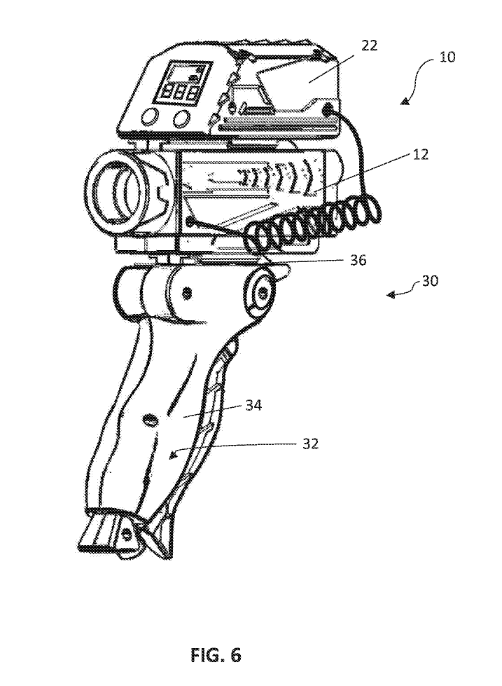

In one further aspect of the present invention, there is provided a device assembly 30 for determining a motion characteristic of a projectile ejected from a toy gun 2. Referring to FIGS. 4 to 6, shown is the device assembly 30 comprising the device 10 as described earlier, and a support 32 adapted to releasably connect with and to provide support to the device 10. Specifically, the support 32 is movable between an extended configuration and a retracted configuration, as illustrated in FIGS. 5 and 6, respectively. When in the extended configuration as shown in FIG. 5, the support 32 is adapted to stand freely on a surface to support the connected device 10; and when in the retracted configuration as shown in FIG. 6, the support 32 provides a handle to allow the device 10 to be held.

In one embodiment, the support 32 may comprise a plurality of legs 34, and preferably, three legs 34 arranged in the form of a tripod which are foldable between the extended configuration and the retracted configuration. When in the extended configuration, the legs 34 are arranged to movably connect such as via a pivot joint at one end adjacent to the device 10, and are spaced apart from one another at an opposing end for engaging the surface. Preferably, the support 32 may further comprise a connecting means 36 for releasably connecting the support 32 with the device 10. For example, the connecting means 36 can be arranged with a configuration similar to the rail or the mount 25 as described above, and the bottom portion of the body 12 can be configured with a corresponding engaging portion for engaging the connecting means 36, such that the body 12 of the device 10 can be slidably connected with or released from the support 32. The processing unit 22 may further be stacked on and connected with the body 12 by a similar releasable engaging mechanism to provide a compact arrangement of the device 10. The extended configuration enables the device assembly 30 to serve as a stand-alone unit capable of determining motion characteristics of moving projectiles ejected from one or more toy guns, which can be identical or different in designs.

In use, the legs 34 of the support 32 can be unfolded to its extended configuration. The support 32 is then adapted to stand freely on a surface to support the connected device 10, and particularly, to support the device 10 in an orientation such that the channel 14 of the body 12 can be arranged to substantially align with the nozzle 4 of the toy gun 2 to receive the ejected projectile from the toy gun 2, as shown in FIG. 4. The foldable legs 34 further allows the support 32 to be converted in its retracted configuration, which provides a compact arrangement of the device assembly 30 with a handle for an easy handling by the user of the device assembly 30, particularly when it is not in use.

The device according to the present invention is advantageous in that it provides a relatively simple and low cost technical solution to simulate the effect of a speed detecting device such as a gun chronograph, which is generally known to be technically sophisticated and costly. The device of the present invention allows a real time determination of one or more motion characteristics of an ejected projectile from the toy gun, such as but not limited to, the velocity of the moving projectile, the projecting angle of the moving projectile, the acceleration of the moving projectile and the estimated distance to be traveled by the moving projectile. Particularly, the device is releasably mountable on a toy gun to allow the device and the gun in becoming a single operating unit. The device may also be releasably mounted on a support foldable between an extended configuration and a retracted configuration. When in the extended configuration, the support can be arranged in the form of a tripod adapted to support the device steadily above a surface for measuring the motion characteristic of the ejected projectile; and when in the retracted configuration, the support provides a more compact configuration for the user's easy handling and storage.

The present description illustrates the principles of the present invention. It will thus be appreciated that those skilled in the art will be able to devise various arrangements that, although not explicitly described or shown herein, embody the principles of the invention and are included within its spirit and scope.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

While the invention has been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

In the claims hereof, any element expressed as a means for performing a specified function is intended to encompass any way of performing that function. The invention as defined by such claims resides in the fact that the functionalities provided by the various recited means are combined and brought together in the manner which the claims call for. It is thus regarded that any means that can provide those functionalities are equivalent to those shown herein.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art is referred to herein, such prior art does not constitute an admission that the prior art forms a part of the common general knowledge in the art.

1. A device for determining a motion characteristic of a projectile ejected from a toy gun, comprising:
a body defining a channel for receiving a moving projectile from the toy gun;
a detecting unit configured to detect motion of the projectile in the channel; and
a processing module configured to generate data defining a motion characteristic of the moving projectile based on the detected motion of the projectile in the channel.

2. The device according to claim 1, wherein the detecting unit comprises at least a first detecting module and a second detecting module, the first detecting module being adapted to detect a first motion of the moving projectile within the channel, and the second detecting module being adapted to detect a second motion of the moving projectile within the channel.

3. The device according to claim 2, wherein the processing module is adapted to electronically connect with the detecting unit, the processing module being adapted to process the first and the second motions detected by the respective first and second detecting modules to thereby generate data defining the motion characteristic of the moving projectile.

4. The device according to claim 2, wherein the first detecting module comprises a first electromagnetic radiation emitter and a first electromagnetic radiation receiver, and the second detecting module comprises a second electromagnetic radiation emitter and a second electromagnetic radiation receiver; the first electromagnetic radiation receiver and the second electromagnetic radiation receiver being adapted to detect electromagnetic radiations emitted from the first electromagnetic radiation emitter and the second electromagnetic radiation emitter, respectively.

5. The device according to claim 4, wherein the first electromagnetic radiation receiver is positioned to oppose the first electromagnetic radiation emitter across the channel, and the second electromagnetic radiation receiver is positioned to oppose the second electromagnetic radiation emitter across the channel.

6. The device according to claim 4, wherein the electromagnetic radiation comprises infrared radiation.

7. The device according to claim 6, wherein the infrared radiation is at a wavelength range from about 800 nm to about 1000 nm.

8. The device according to claim 7, wherein the infrared radiation is at a wavelength of about 940 nm.

9. The device according to claim 2, wherein the first and the second detecting modules of the detecting unit are spaced apart from each other along at least part of a length of the channel.

10. The device according to claim 1, wherein the motion characteristic comprises one or more of the following: a velocity of the moving projectile, a projecting angle of the moving projectile, an acceleration of the moving projectile and an estimated distance to be traveled by the moving projectile.

11. The device according to claim 10, wherein the velocity of the moving projectile comprises at least one of a horizontal velocity component and a vertical velocity component.

12. The device according to claim 1, wherein the processing module is provided at a processing unit releasably engageable with the body of the device.

13. The device according to claim 12, wherein the processing unit is releasably mountable at a part of the toy gun.

14. The device according to claim 1, wherein the device is releasably connectable with the toy gun.

15. The device according to claim 14, wherein, when the device is releasably connected with the toy gun, the channel of the body is substantially aligned with a nozzle of the toy gun for receiving the ejected projectile from the toy gun.

16. The device according to claim 1, further comprising a display screen adapted to display the generated data defining the motion characteristic of the moving projectile.

17. The device according to claim 1, wherein the detecting module further comprises one or more accelerometers.

18. A device assembly for determining a motion characteristic of a projectile ejected from a toy gun, comprising:
the device in accordance with claim 1; and
a support adapted to releasably connect with and to provide support to the device;
wherein the support is movable between an extended configuration and a retracted configuration; where, when in the extended configuration, the support is adapted to stand freely on a surface to support the connected device; and where, when in the retracted configuration, the support provides a handle to allow the device to be held.

19. The device assembly according to claim 18, wherein the support comprises a plurality of legs foldable between the extended configuration and the retracted configuration.

20. The device assembly according to claim 19, wherein, when in the extended configuration, the plurality of legs are arranged to movably connect at one end adjacent to the device in use, and are spaced apart from one another at an opposing end for engaging the surface.

21. The device assembly accordingly to claim 18, wherein the support comprises a connecting means for releasably connecting the support with the device.

22. The device assembly according to claim 21, wherein the connecting means of the support is adapted to engage a corresponding engaging portion of the device.

23. A method of determining a motion characteristic of a projectile ejected from a toy gun by using the device of claim 2, comprising steps of:
detecting a first motion of the projectile entering the channel of the body by the first detecting module;
detecting a second motion of the projectile exiting the channel of the body by the second detecting module;
processing the first and the second motions detected from the detecting steps by the processing module; and
generating data defining a motion characteristic by the processing module.

24. The method according to claim 23, wherein the step of detecting a first motion comprises emitting a first electromagnetic radiation from the first electromagnetic radiation emitter, and subsequently, receiving the emitted first electromagnetic radiation by the first electromagnetic radiation receiver; and the step of detecting a second motion comprises emitting a second electromagnetic radiation from the second electromagnetic radiation emitter, and subsequently, receiving the emitted second electromagnetic radiation by the second electromagnetic radiation receiver.

25. The method according to claim 24, wherein the steps of detecting a first motion and detecting a second motion further comprise of the projectile interfering with the first electromagnetic radiation when entering the channel of the body, and subsequently, the projectile interfering with the second electromagnetic radiation when exiting the channel of the body.

26. The method according to claim 25, wherein the step of processing the first and the second motions comprises a step of measuring a time between the interference of the first electromagnetic radiation by the projectile entering the channel, and the interference of the second electromagnetic radiation by the projectile exiting the channel.

27. The method according to claim 26, wherein the step of generating data comprises calculating data of the motion characteristic based on the time measured by the processing step.

28. The method according to claim 23, further comprising displaying the data on a display screen of the device.
